(19) United States
(12) Patent Application Publication
(10) Pub. No.: US 2004/0013889 A1
(43) Pub. Date: Jan. 22, 2004

(54) Sandwich type board

(76) Inventors: Marcos Del Rio Carbajo, Beasain (ES); Jose Ramon Oyarzabal, Zizurkil (ES)

Correspondence Address: MUSERLIAN AND LUCAS AND MERCANTI, LLP, 475 PARK AVENUE SOUTH, NEW YORK, NY, 10016, US

(21) Appl. No.: 10/278,165

(22) Filed: Oct. 22, 2002

(30) Foreign Application Priority Data
Jul. 19, 2002 (ES) P200201696

(51) Int. Cl. B32B 15/04

(52) U.S. Cl. 428/461; 428/457

(57) ABSTRACT

Sandwich type board, of the kind that is comprised of several successive layers and has an outside film on the top side and/or bottom side of a transparent acrylic type polymer, which a transparent thermoplastic has been added to, which is insoluble or slightly soluble in organic solvents; and the surface films of the top side and bottom side have similar thermal dilation coefficients, humidity absorption coefficient and grammage.

Application in the construction field.

The applicant is a manufacturer of sandwich type boards of the kind that use several successive layers of cellulose material impregnated in polymerisable resins and which are submitted to pressing to give rise to a compact board.

These boards degrade on the surface due to the action of the UV-rays of the sun, so a surface film of an acrylic type polymer was added; for example, polyacrylate or polymetalmethacrylate or a compound of them, which was transparent to the sunlight but which absorbed the UV rays (WO 01/05587).

The applicant manufactures these boards for outside panelling with accelerated ageing conditions in laboratory of 3,000 hours, which pre-supposes a minimum durability of 10 years.

During the year 2000 the applicant's Commercial Dept. received unforeseen complaints from the customers. The surface of the outside boards was degraded with whitish stains, loss of gloss and clear warping.

After the applicant had studied the damaged boards, he discovered small cracks in the surface acrylic film.

The applicant repeated the tests under extremely bad environmental pollution conditions without the surface degradation observed on the boards targeted by the customers' complaints taking place.

This led the applicant to think that the cause of the degradation was brought about involuntarily by the actual customers due to the different products used to maintain the facades clean, as these contain different organic solvents such as ethyl alcohol, methyl ethyl ketone, hexane, benzene, toluene, ethyl acetate, Reproducing the situation in the laboratory, with attack tests of these compounds, the same deterioration is appreciated on the surface of the board, that is, loss of gloss, colour and appearance of cracks detected by the applicant, which indicates that the cause of the problem has been identified.

After studying the problem of the cracking in the surface film, the applicant considers that the bottom-line cause is a cracking of the chemical structure of the acrylic polymer of the surface film.

A breakage of the chemical bonds of the acrylic polymer or acrylic compound is noticed in the cracking, caused by the attack of the organic solvents.

After numerous tests, the applicant has reached the conclusion that the solution to the problem consists in the acrylic polymer being re-structured by introducing another polymer that does not dissolve in organic solvents. Good results are obtained in the laboratory by adding a thermoplastic polymer to the acrylic polymer, which is transparent, insoluble or not very soluble in organic solvents.

After studying the problem of warping, the applicant considers that the bottom-line cause is found in the different behaviour of the top and bottom of the board when both have a different nature. The cause of the warping comes from the different coefficients of thermal dilation, different coefficients of humidity absorption and different grammages (weight/surface) of both sides of the board.

For the problem of the warping, the solution is found by adding a film to the bottom (the reverse) of the board with similar relations in values in grammage, coefficient of thermal dilation, and coefficient of humidity absorption.

To understand the subject of this invention better, a preferential form of practical execution is illustrated on the drawings, subject to accessory changes that take nothing away from its foundation.

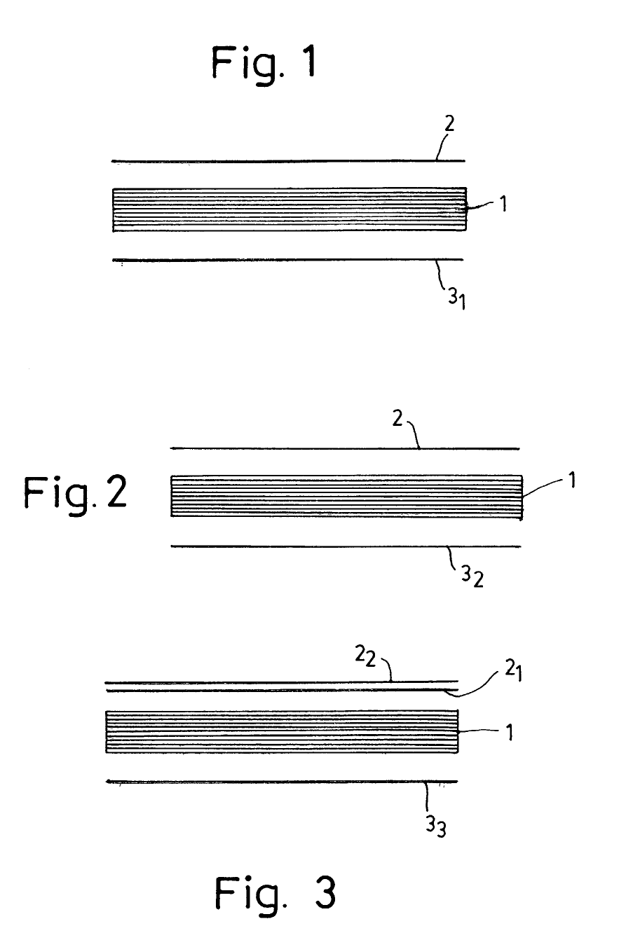

FIG. 1 is a schematic representation of a first practical execution of the board targeted by the invention.

FIG. 2 is a schematic representation of a second practical execution of the board targeted by the invention.

FIG. 3 is a schematic representation of a third practical execution of the board targeted by the invention.

Below an example of a non-limiting practical execution is described of this invention.

FIGS. 1 and 2 show a board with a group of inner layers (1), for example a package of cellulose absorbent sheets impregnated in phenol resin (kralf), sheets of wood, packages of tones, etc., whose components and stratification are known in the state of the technique.

As an outer side (2) it has a film of acrylic type polymer, for example an acrylate, a methacrylate, a mixture of them, etc., to which a second component has been added, consisting of a thermoplastic polymer, which is slightly soluble or insoluble in organic solvents, such as, for example, hexane, benzene, toluene, methyl-ethyl-ketone, etc.

FIG. 3 shows: the inner layers (1) with an acrylic type outer film (2₁) and on which an additional thermoplastic polymer film (2₂) has been placed, for example, vinylidene polyfluoride, polycarbonate, etc. of the same nature as the thermoplastic polymer used for the executions of FIGS. 1 and 2.

Tests 1—An acrylate was mixed with 5% in weight of a polysulphone (PSU) and the resulting film was applied to a conventional board. The board was submitted to 24 h/RT (24 hours exposure at room temperature) to the presence of alcohol, without noticing visible changes on the surface of the film.

The same test was repeated with the successive presence of hexane, benzene and toluene, with identical results.

Tests 2—A methacrylate was mixed with 11% in weight of a polycarbonate (PC), the conditions described in test 1 were reproduced and the results were the same: lack of visible changes on the surface of the film.

Tests 3—An acrylate was mixed with 18% of vinylidene polyfluoride (PVDF) the conditions described in test 1 were reproduced and it was also submitted to the presence of methyl-ethyl-ketone. The results with PVDF were the best of all the tests with thermoplastics.

In laboratory, the acrylic film with a transparent thermoplastic polymer insoluble in organic solvent only presents a slight change in gloss faced with the presence of THF or ethyl acetate.

It can be deduced from these tests that the presence of thermoplastic between 5% and 20% gives good results.

In view of these results the applicant assumed that perhaps it was not necessary to add the thermoplastic to the acrylic, but that it would be sufficient to cover the acrylic type film (2₁) with an addition film (2₂) of transparent thermoplastic insoluble in organic solvents.

In laboratory the supposition turned out to be true and the board behaved excellently with two superimposed surface films (2₁), (2₂), the known acrylic type one and the additional one of thermoplastic.

In order for the acrylic film to adhere to the inner layers of the sandwich board, the inner surface of the acrylic film is impregnated with a substance substance, adherent to the immediately previous layer of the sandwich board.

Related to the warping of the board, a film or films (3) are placed on the bottom side of the board, which, together have similar coefficients of thermal dilation, coefficient of humidity absorption and grammage as the film or films (2) used on the top side.

In FIG. 1 phenol films (3₁) have been used on the bottom side, in FIG. 2 a melamine film (3₂) and in FIG. 3 an aluminium sheet/film (3₃).

By way of an example the following tests are mentioned:

Test 1—An acrylic film is used as the top side with 10% in weight of vinylidene polyfluoride (PVDF) with 68 g/m² grammage, with a linear thermal dilation coefficient of 10 10^{-5×}l/k and a humidity absorption coefficient of 0.2%. An aluminium sheet of 12 μm (32 g/m²) was used as the bottom side, with a linear thermal dilation coefficient of 25 10^{-6×}l/k and a humidity absorption coefficient of 0.05%. Optimum result.

Test 2—An acrylic film is used with 10% in weight of vinylidene polyfluoride (PVDF) with 68 g/m² grammage, with a linear thermal dilation coefficient of 10 10^{-5×}l/k and a humidity absorption coefficient of 0.2%. A 50 g/m² polyolefin film was used as bottom side with a liner thermal dilation coefficient of 15 10^{-5×}l/k and a humidity absorption coefficient of 0.15%. Very good result.

Test 3—An acrylic film is used with 10% in weight of vinylidene polyfluoride (PVDF) with 68 g/m² grammage, with a linear thermal dilation coefficient of 10 10^{-5×}l/k and a humidity absorption coefficient of 0.2%. The same kind of film is used on the bottom side. Excellent result.

1. Sandwich type board, of the kind comprised of several successive layers and which, on the outside, has, as top side and/or bottom side, a film of a transparent acrylic type polymer, characterised because a transparent thermoplastic, which is insoluble or slightly soluble in organic solvents, is added to the acrylic type polymer film.

2. Sandwich type board, according to previous claim, characterised because the transparent thermoplastic is added by mixing it to the acrylic type polymer.

3. Sandwich type board, according to firm claim, characterised because the transparent thermoplastic is added as a film on the acrylic nature polymer film.

4. Sandwich type board, according to previous claim, characterised because the transparent thermoplastic is added in a proportion between 5% and 20% in weight respect to the acrylic type polymer.

5. Sandwich type board, according to the first claim, characterised because the transparent thermoplastic is the vinylidene polyfluoride (PVDF).

6. Sandwich type board, according to the first claim, characterised because the surface films of the top side and bottom side have similar thermal dilation coefficient, humidity absorption coefficient.

7. Sandwich type board, according to the sixth claim, characterised because the outside film of the bottom side is an aluminium sheet.

8. Sandwich type board, according to the sixth claim, characterised because the outside film of the bottom side is a polyolefin film.

9. Sandwich type board, according to the sixth claim, characterised because the surface films of the top side and bottom side have similar grammage.
